(19) United States
(12) Patent Application Publication
(10) Pub. No.: US 2003/0065495 A1
(43) Pub. Date: Apr. 3, 2003

(54) Disc drive head-media spacing modeling and applications

(76) Inventors: Shih-Fu Lee, Fremont, CA (US); Yong Hu, Fremont, CA (US); David Kuo, Palo Alto, CA (US)

Correspondence Address: MOSER, PATTERSON & SHERIDAN, LLP, 350 Cambridge Avenue, Suite 250, Palo Alto, CA, 94306, US

(21) Appl. No.: 09/887,697

(22) Filed: Nov. 1, 2001

Related U.S. Application Data
(60) Provisional application No. 60/276,764, filed on Mar. 16, 2001.

(51) Int. Cl. G06G 7/48

(52) U.S. Cl. 703/6

(57) ABSTRACT

A method and apparatus for disc drive modeling to determine head-to-media spacing subject to disc media topography, roughness and waviness, is disclosed. More particularly, an equation describing head-to-media spacing associated with roughness and waviness of a disc media surface is described. A process for simulating a head traveling over a reference disc media surface is used to implement such an equation. This simulation results in an air bearing transfer function for a spectral density, which is convolved with a power spectral density function for a disc media surface under test. Such a result may be used to predict glide avalanche for the head and the disc media under test.

### CROSS-REFERENCE TO RELATED APPLICATIONS

This application claims benefit of U.S. provisional Patent Application, application No. 60/276,764, filed Mar. 16, 2001, which is incorporated by reference herein in its entirety.

### FIELD OF THE INVENTION

The present invention generally relates to modeling a disc drive, and more particularly to disc drive modeling for determining head-to-media spacing dependent on disc media surface topography and air bearing design.

### BACKGROUND OF THE INVENTION

A form of an information storage and retrieval device is a hard disc drive [hereinafter “disc drive”]. A disc drive is conventionally used for information storage and retrieval with computers, data recorders, redundant arrays of independent discs (RAIDs), multi-media recorders, and the like. A disc drive comprises one or more disc media.

Each disc media comprises a substrate upon which materials are deposited to provide a magnetically sensitive surface. Though some disc media use both top and bottom surfaces, for purposes of clarity a single-sided disc media, for example using only a top surface, is described. Referring to FIG. 1, there is shown a cross-sectional view of a portion of a disc media 9 having a substrate 8 having a plurality of layers 7 formed on it. Material forming substrate 8 is characterized as “non-magnetic,” examples of substrate materials include, but are not limited to, glass, ceramic, glass-ceramic composite, polymer, non-ferrous metal, metal-ceramic composite, metal alloy, and the like. Conventionally, a plating layer, an interlayer, a magnetic recording layer, a protective layer, and a lubricant layer are deposited upon the substrate to form a magnetically sensitive and alterable surface. Various known combinations of layers of materials may be used.

In forming a disc media, a substrate is ground or polished, conventionally by chemical-mechanical or mechanical polishing, to provide a substantially planar surface. Optionally, the substrate may be mechanically-circumferentially polished to create circumferential topography. This is sometimes referred to as “texturing.” Layers of materials are substantially uniformly deposited on this substantially planar surface to provide magnetic properties for writing to and reading from the disc media. After deposition of layers, the substrate assembly is polished, conventionally by chemical-mechanical or mechanical polishing, to provide a textured surface.

However, as a slider having a read/write head or separate read and write heads [herein after collectively and singly referred to as “head”] travels less than approximately 0.5 micro-inches (0.5 μ inches) or approximately 130 Angstroms (A) from a disc media surface (“fly height”) and as surface roughness may be maintained to less than approximately 3 A, surface topography non-planarity or “waviness,” whether due to polishing or texturing or a combination of both, is a significant factor in disc drive performance. Accordingly, a model that takes into account waviness, as well as roughness, would be desirable to predict spacing between a head and a disc media surface [“head-media spacing” or “HMS”] for determining glide avalanche performance.

In “Effects of Disc Micro-Waviness in an Ultra-High Density Magnetic Recording System” presented by Wei Yao, David Kuo and Jing Gui at ASME Tribology Conference 1999 in Orlando, Fla. [hereinafter “Yao, et al.”], a model to assess micro-inch waviness contribution to disc avalanche was revealed. In Yao, et al., a product head with negative air bearing design was used to assess head-to-disc spacing modulation. Based on experimental results by Yao, et al, an empirical relationship was established to assess head modulation spacing loss. In other words, Yao, et al. showed that waviness limits operational proximity of a head to a disc media surface. Conventionally, for purposes of magnetic performance of a non-contact read/write design, it is desirable to have a head as close as possible to a disc media surface without making contact. As a head has some degree of travel toward and away from the disc media surface, a minimum distance must be maintained to avoid head-to-surface contact, and a maximum distance may be in place to limit reduction in magnetic performance. However, the Yao, et al. model does not take into account operational parameters such as air bearing design, fly height and weighted contribution of disc topography at different wavelengths, in these respects the Yao, et al. model is a rough and empirical model.

Accordingly, it would be desirable to provide a dynamic disc media surface topography model that avoids one or more of the limitations of the Yao, et al. model.

### SUMMARY OF THE INVENTION

The present invention generally provides method and apparatus for disc drive HMS modeling. More particularly, an equation describing components of head-to-media spacing associated with roughness and waviness of a disc media surface is described. A process for simulating a head traveling over a reference disc media surface is used to implement such equation. This simulation results in an air bearing transfer function for a spectral density, which is convolved with a power spectral density function for the disc media surface to provide a head-to-media spacing spectrum of modulation. Such a result may be used to predict glide avalanche for disc media of differing material compositions and process manufacture.

An aspect of the present invention is a method of determining a portion of a head-media spacing modulation spectrum of a portion of an actual disc media surface. A head passing in near proximity to a simulated disc media surface is simulated to generate an air bearing transfer function for a spectral density. A topography function is generated for the actual disc media surface. The topography function and the air bearing transfer function are convoluted to provide the head-media spacing modulation spectrum.

Another aspect of the present invention is a method for predicting glide avalanche performance. Head-media spacing for waviness is determined for each substrate in a group of substrates, and head-media spacing for roughness is determined for each substrate in the group of substrates. The head-media spacing for roughness and the head-media spacing for waviness are square-root summed for each substrate in the group of substrates for correlating results from the square-root-summing.

Another aspect of the present invention is a model for glide avalanche (GA) for a disc media having a topography. The model comprises an equation where the GA equals:

a [Λ²(λ)Y(λ)dλ]^{/2}+b,

where a and b are constants, Λ is an air bearing transfer function in amplitude gain, Y is the power spectral density function of disc topography, and λ is wavelength.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a cross-sectional view of a portion of a disc media of the prior art having a substrate having a plurality of layers formed on it.

FIG. 2 is a wavelength versus HMS modulation amplification factor graph in accordance with one or more aspects of the present invention.

FIG. 3 is a flow diagram of an exemplary embodiment of a process for determining HMS caused by disc media topography in accordance with one or more aspects of the present invention.

FIG. 4 is an elevation view of an exemplary embodiment of a disc media of the prior art.

FIG. 5 is a block diagram of a computer system programmed in accordance with one or more aspects of the present invention.

FIG. 6 is a plot of HMS_RMS versus GA for HMS for various exemplary embodiments of the invention.

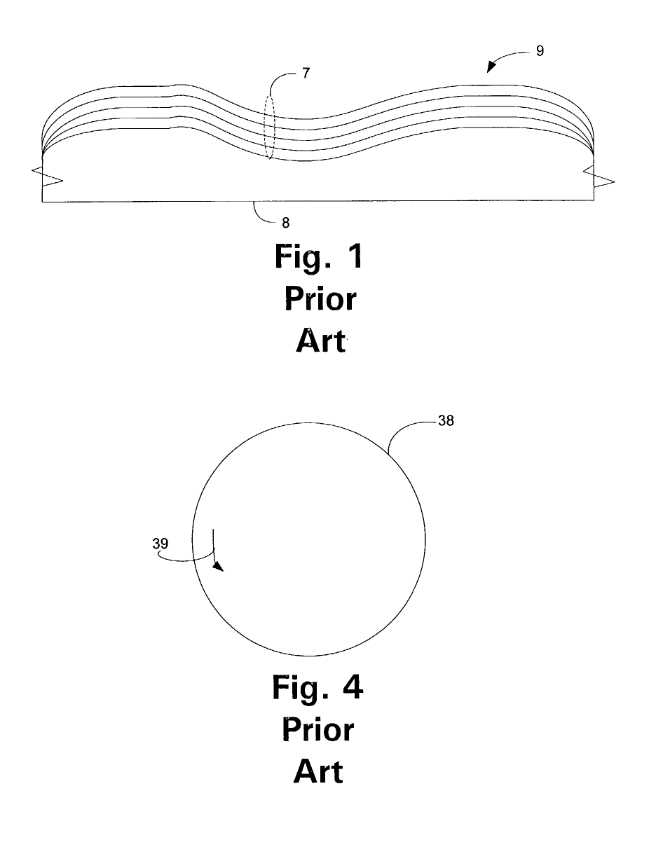

While foregoing is directed to the preferred embodiment of the present invention, other and further embodiments of the invention may be devised without departing from the basic scope thereof, and the scope thereof is determined by the claims that follow.

### DETAILED DESCRIPTION OF THE DRAWINGS

Glide avalanche is a minimum flying height of a head, such as a glide head (“glider”), product head, negative air bearing slider head, and the like. The present invention provides a new glide avalanche (GA) model, namely

GA=a[∫Λ²(λ)Y(λ)dλ]^{½}+b (1)

where the integral boundaries are from zero to one revolution of a disc media.

Constant “a” in Equation (1) represents a relationship of glide avalanche to root-mean-square (RMS) of head-disc modulation. Constant “b” in Equation (1) represents other possible effects, such as roughness of the lubricant and head. Scaling factor “a” and offset “b” may be experimentally derived.

Function “Y” in Equation (1) is a power spectral density of disc topography. Function “Λ” in Equation (1) is an air bearing transfer function in amplitude gain. Wavelength “λ” in Equation (1) is a variable dependent on disc topography. From Equation (1), HMS modulation may be described as,

HMS_Modulation=[∫Λ²(λ)Y(λ)dλ]^{½} (1A)

where the integral boundaries are from zero to one revolution of a disc media.

For purposes of clarity, is useful to relate HMS modulation with disc media surface processing affecting topography, namely, texturing and polishing. Topography generated by texturing is conventionally attributed to a “roughness” category. Conventionally, a head does not follow disc media contour caused by roughness. This is because roughness conventionally produces a high frequency when disc media contour is converted to frequency. Whereas, topography created with polishing, conventionally produces a low frequency when disc media contour is converted to frequency, which is more likely to affect head following. According, Equation (1) may be expressed as,

$$GA = {a [ {\int }_{0}^{c} Y ( λ ) ⅆ λ + {\int }_{c}^{1 rev .} {Λ}^{2} ( λ ) Y ( λ ) ⅆ λ ]}^{1 / 2} + b \qquad ( 2 )$$

where HMS variability due to roughness is,

$$HMS\_Rq = {[ {\int }_{0}^{c} Y ( λ ) ⅆ λ ]}^{1 / 2} \qquad \text{(2A)}$$

and where HMS variability due to waviness is,

$$HMS\_Wq = {[ {\int }_{c}^{1 rev .} {Λ}^{2} ( λ ) Y ( λ ) ⅆ λ ]}^{1 / 2} \qquad \text{(2B)}$$

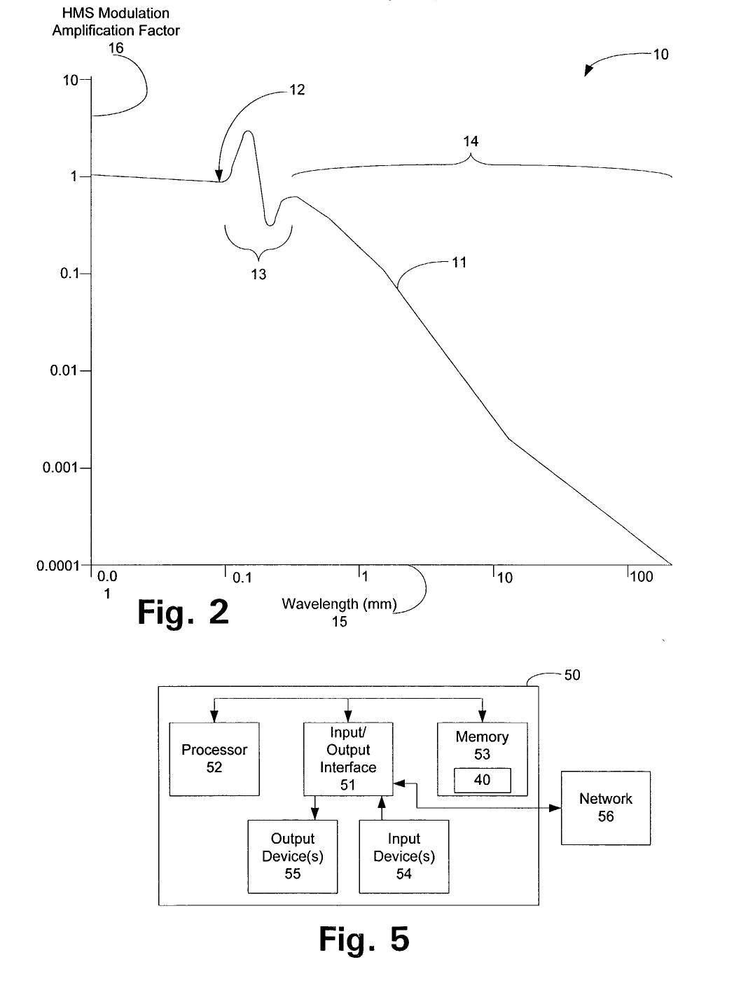

Integral boundary “c” is a wavelength selected somewhat arbitrarily as a high frequency and low frequency interface, as described in more detail with respect to FIG. 2. Thus, Equations (1) and (2) cover spectral density from roughness created aberrations to waviness created aberrations. However, Equation (2) allows evaluation of roughness, conventionally caused by texturing, separately from waviness, conventionally caused by polishing.

Referring to FIG. 2, there is shown a wavelength 15 versus HMS modulation amplification factor 16 graph 10 in accordance with one or more aspects of the present invention. Line 11 represents an air bearing transfer function for a respective head under test.

Wavelength 15 versus HMS modulation amplification factor 16 indicates how well a head follows a disc media contour or “following” performance. Graph or plot 10 is a method for determining “following” performance of a head. As shown, as wavelength is increased along axis 15, following improves, namely, HMS modulation amplification factor 16 is reduced. Region 14 is a disc media surface contour low frequency region or head following region. Thus, as wavelength gets longer indicating a flatter disc media surface contour, frequency approaches zero. From wavelength 0.01 mm to location 12, there is limited, if any, head following disc media contour. This is a high frequency region, as mentioned above, and accordingly location 12 is a possible point for selection in association with integral boundary “c”. Region 13 indicates a resonant frequency area, resulting in some or no following.

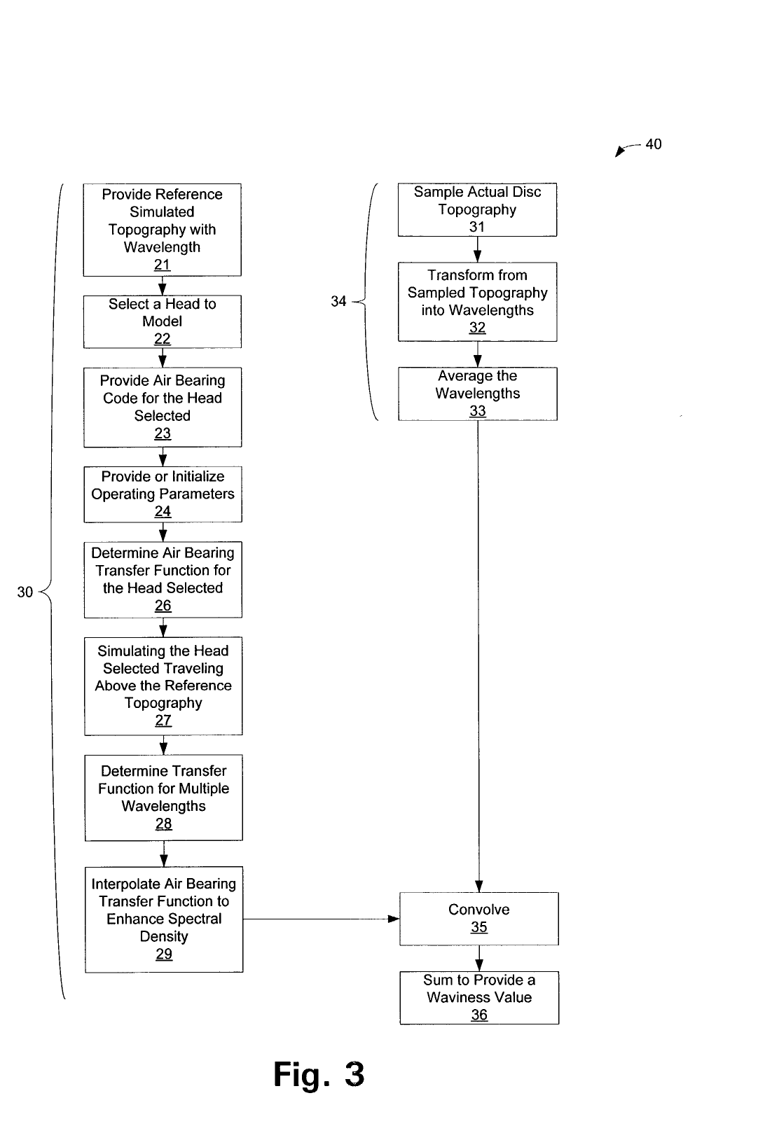

Referring to FIG. 3, there is shown a flow diagram of an exemplary embodiment of a process 40 for determining HMS caused by topography in accordance with one or more aspects of the present invention. Process 40 comprises steps 30 for generating an air bearing transfer function with a spectral density.

At step 21, a simulated topography is provided as a reference topography. Accordingly, such a reference disc media surface topography may be provided as a sinusoidal waveform having a wavelength, λ, with a fixed amplitude. More particularly, wavelength, λ, may be in a down track direction, as illustratively shown by arrow 39 on disc media 38 of FIG. 4, and amplitude may be set to one.

At step 22, a head to be modeled is selected. At step 23, air bearing code for the head selected is obtained. Such air bearing code may be used to simulate flying behavior of the head selected at step 22, namely flying the head above the simulated topography provided at step 21. Known heads, and their associated known air bearing codes, may be used for steps 22 and 23, respectively.

At step 24, operating conditions are provided, such as linear velocity, temperature and ambient pressure. If operating conditions are not provided, default operating conditions may be used for variable initialization. Operating conditions of disc drives are well-known.

At step 26, an air bearing transfer function, Λ²(λ), for amplitude gain for the head selected at step 22 is determined for the selected wavelength of the simulated topography of step 21, where Λ²(λ) may be calculated from the air bearing code provided at step 23.

At step 27, a simulation of the head selected at step 22 traveling over the disc media surface topography provided at step 21 is run using in part the air bearing code obtained at step 23. Such a simulation may be run on a programmed computer, such as a personal computer or workstation, with an operating system, such a Windows, Windows-like, UNIX or UNIX-like operating system.

At step 28, at each of a plurality of disc media wavelengths, corresponding HMS modulation is computed or otherwise determined. HMS modulation is also the HMS amplification factor. Accordingly, a transfer function for a plurality of wavelengths is determined. However, to increase spectral density of such transfer function, optionally at step 29, gradations of the wavelengths are generated by interpolating transfer function of step 28.

Accordingly, after completion of steps 30, a dynamic air bearing transfer function for a selected head has been generated for a spectral density corresponding to a reference disc media surface topography. Thus, transfer function, Λ²(λ) from Equation (2), for amplitude gain has been determined for the spectral density. Notably, this air bearing transfer function is a weighted function, as it quantifies importance of each wavelength. This provides a means to monitor results of substrate processing.

Steps 34 are to generate a power spectral density function or an RMS spectral function for an actual, as opposed to a reference, topography under consideration. At step 31, measurements are taken from a disc media surface. Notably, taking measurements by discrete sampling provides a topographical function. In other words, taking measurements from a fixed reference level to disc media surface allows contour to be plotted, calculated or otherwise determined. This topographical function is transformed at step 32 from physical contour into wavelength. For example, a discrete Fourier transform may be used for this transformation. At step 33, an average, or more particularly an RMS, of the transform result is calculated to provide a power spectral density function, namely, topography function Y(λ) from Equation (2).

At step 35, the air bearing transfer function from step 29, with its spectral density, is convolved with the power spectral density function from step 34. This produces an HMS modulation spectrum. Optionally, at step 36, this HMS modulation spectrum may be reduced to an HMS waviness value for the actual topography under evaluation. For example, such HMS modulation spectrum may be simplified as the square-root-sum of its spectral components to provide an HMS waviness value, namely, HMS_Wq.

Referring to FIG. 5, there is shown a block diagram of a computer system 50 programmed in accordance with an aspect of the present invention. Computer system 50 comprises processor 52, input/output interface 51, memory 53, one or more input devices 54, and one or more output devices 55. Computer system 50 may be coupled to a network 56, such as a portion of an intranet or the Internet. Computer system 50 is programmed with program 40, corresponding to process 40 of FIG. 3, at least a portion of which may be stored in memory 53 or provided from network 56. An embodiment of the present invention is implemented as a program product for use with a computer system such as, for example, target computer system 50. The program(s) of the program product defines functions of the embodiments and can be contained on a variety of signal-bearing media, which include, but are not limited to: (i) information permanently stored on non-writable storage media (e.g., read-only memory devices within a computer such as CD-ROM discs readable by a CD-ROM drive); (ii) alterable information stored on writable storage media (e.g., discs within a floppy drive or hard disc drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

As mentioned above, topography is a result of both polishing and texturing. Three substrates from three different polishing machines, namely substrates 1, 2 and 3, where textured with two different textures, and each resulting substrate assembly exhibited different waviness, as set forth in Table 1, and different roughness, as set forth in Table 2.

TABLE 1

| | HMS_Wq | Std. | | HMS_Wq | Std. |
|---|---|---|---|---|---|
| Substrate Assembly | (A) | Dev. (A) | Substrate Assembly | (A) | Dev. (A) |
| Substrate 1 and | 4.76 | 0.38 | Substrate 1 and | 4.25 | 0.36 |
| Texture 1 | | | Texture 2 | | |
| Substrate 2 and | 3.98 | 0.27 | Substrate 2 and | 3.47 | 0.30 |
| Texture 1 | | | Texture 2 | | |
| Substrate 3 and | 3.31 | 0.39 | Substrate 3 and | 3.135 | 0.44 |
| Texture 1 | | | Texture 2 | | |

TABLE 2

| | HMS_Rq | | | HMS_Rq | |
|---|---|---|---|---|---|
| Substrate/Texture | (A) | Std. Dev. (A) | Substrate/Texture | (A) | Std. Dev. (A) |
| Substrate 1 and | 5.102 | 0.07 | Substrate 1 and | 2.142 | 0.01 |
| Texture 1 | | | Texture 2 | | |
| Substrate 2 and | 5.026 | 0.04 | Substrate 2 and | 1.94 | 0.05 |
| Texture 1 | | | Texture 2 | | |
| Substrate 3 and | 5.21 | 0.11 | Substrate 3 and | 1.984 | 0.02 |
| Texture 1 | | | Texture 2 | | |

HMS_Wq was obtained from the transfer function of a glide head traveling at 100 inches per second (ips) or 254 centimeters per second. Each substrate assembly in Table 1 has a different waviness. In Table 1, substrate assemblies with texture 1 have higher waviness than substrate assemblies with texture 2, while Table 2 indicates that texture 1 generates rougher surfaces than texture 2. Accordingly, waviness is affected by polishing, texturing, or a combination of both. Notably, Rq, surface roughness, is equal to the HMS caused by the roughness, namely, Rq equals HMS_Rq. However, this is not true as between waviness, Wq, and HMS due to waviness, HMS_Wq.

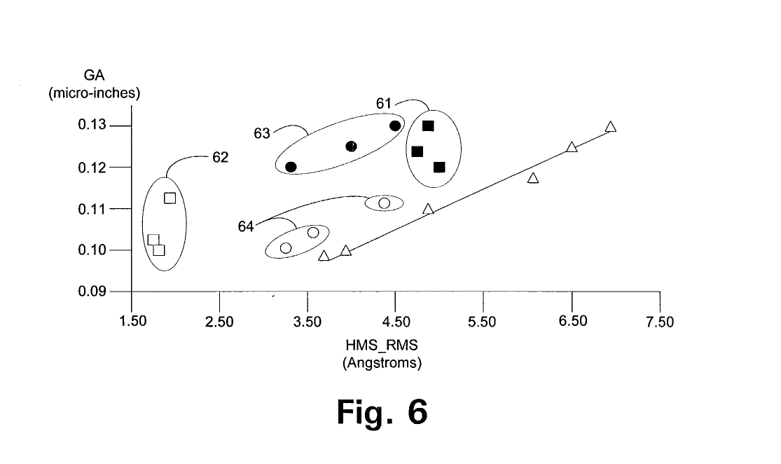

A glide avalanche test, which measures head-to-media clearance, was performed on each of the six substrate assemblies. Correlation between GA and topography, HMS_Wq, HMS_Rq, and RMS sum of HMS_Wq and HMS_Rq, were plotted in FIG. 6.

Referring to FIG. 6, there is shown a plot of HMS_RMS versus GA for HMS for exemplary embodiments of surfaces in accordance with one or more aspects of the present invention. GA performance for HMS_Rq for substrates with texture 1, group 61, is separate from GA performance for HMS_Rq for substrates with texture 2, group 62. GA performance for HMS_Wq for substrates with texture 1, group 63, is separate from GA performance for HMS_Wq for substrates with texture 2, group 64. If this were the end of the inquiry, there would be little correlation for finding a GA performance predictor. However, GA performance for RMS sums of HMS_Wq and HMS_Rq for the six embodiments indicated correlation, as shown with line 66. For this example, line 66 may be described as,

y=0.009×+0.0671 (3)

where y is the slope of line 66, and where

ti x=[(HMS_Wq)²+(HMS_Rq)²]^{½}. (3A)

Accordingly, line 66 may be used for finding a smaller GA to improve performance. In other words, short and long wavelength features of a disc media surface may be characterized and correlated with GA. Thus, polishing or texturing or both may be characterized for different materials in order to determine which substrate assemblies yield better GA performance. Moreover, head following performance may be determined for different substrates, as well as different heads.

While foregoing is directed to the preferred embodiment of the present invention, other and further embodiments of the invention may be devised without departing from the basic scope thereof, and the scope thereof is determined by the claims that follow.

1. A method of determining head-media spacing (HMS) due to waviness of a disc media surface, comprising:
generating an interpolated air bearing transfer function for a spectral density comprising:
providing a simulated disc topography having a wavelength;
selecting a head to model;
providing air bearing code for the head selected;
providing operation parameters;
determining an air bearing transfer function from the air bearing code;
simulating the head passing over the disc topography with the air bearing code;
determining simulated head-media spacing modulation for each of a plurality of disc wavelengths;
interpolating the air bearing transfer function with gradations of the wavelengths to provide the interpolated air bearing transfer function for the spectral density;
generating a power spectral density function comprising:
sampling actual disc topography of the disc media surface;
discrete Fourier transforming the actual disc topography sampled to a frequency domain to provide a sample topography spectrum;
root-mean-squaring the sampled topography spectrum to provide the power spectral density function;
convolving the power spectral density function with the air bearing transfer function to provide an HMS modulation spectrum for the sample topography spectrum; and
summing the HMS modulation spectrum to provide a value for the HMS of the disc media surface sampled.

2. The method of claim 1 wherein the providing of the simulated disc topography comprises providing a sinusoidal waveform having amplitude set at unity.

3. The method of claim 3 wherein the wavelength is in a down track direction.

4. The method of claim 3 wherein the operation parameters comprise at least one of linear velocity, temperature and ambient pressure.

5. A method of determining a portion of a head-media spacing modulation spectrum of a portion of an actual disc media surface, comprising:
simulating a head passing in near proximity to a simulated disc media surface to generate an air bearing transfer function for a spectral density;
generating a topography function for the actual disc media surface; and
multiplying the topography function and the air bearing transfer function to provide the head-media spacing modulation spectrum.

6. The method of claim 5 further comprising summing the head-media spacing modulation spectrum to provide a head-media spacing waviness value for the disc media surface.

7. The method of claim 5 wherein the generating of the power spectral density function comprises:
sampling topography of the portion of the actual disc media surface;
translating the actual disc topography sampled to wavelengths to provide an sampled topography spectrum; and
averaging the sampled topography spectrum to provide the topography function.

8. The method of claim 5 wherein the simulating comprises:
providing a simulated disc topography having a wavelength;
selecting a head to model;
providing air bearing code for the head selected;
providing operation parameters;
determining an air bearing transfer function from the air bearing code;
determining simulated head-media spacing modulation for each of a plurality of disc wavelengths; and
interpolating the air bearing transfer function with gradations of the wavelengths to provide the air bearing transfer function for the spectral density.

9. The method of claim 5 further comprising:
providing a group of substrates;
determining head-media spacing for waviness for each substrate in the group of substrates; and
determining head-media spacing for roughness for each substrate in the group of substrates.

10. The method of claim 9 further comprising:
square-root summing the head-media spacing for roughness and the head-media spacing for waviness for each substrate in the group of substrates; and
correlating results from the square-root-summing.

11. The method of claim 5 further comprising providing a model for glide avalanche (GA), the model comprising:
an equation where the GA equals
a[Λ²(λ)Y(λ)dλ]^{½}+b,
where a and b are constants, Λ is an air bearing transfer function, Y is a topography function, and λ is wavelength.

12. The method of claim 11 wherein the model comprises integral boundaries from zero to one revolution of the disc media.

13. The method of claim 5 further comprising providing a model for glide avalanche (GA), the model comprising:
an equation where the GA equals
a[Y(λ)dλ+Λ²(λ)Y(λ)dλ]^{½}+b,
where a and b are constants, Λ is an air bearing transfer function, Y is a topography function, and λ is wavelength.

14. The method of claim 13 wherein the model comprises a constant c for breaking the equation into two integrals.

15. The method of claim 14 wherein the constant c is between high frequency region and resonant frequency region.

16. A method of determining head-media spacing (HMS) modulation model, comprising:
providing a simulated disc topography having a wavelength;
selecting a head to model;
providing air bearing code for the head selected;
providing disc drive operation parameters;
determining an air bearing transfer function from the air bearing code;
simulating the head passing over the disc topography with the air bearing code; and
determining simulated head-media spacing modulation for each of a plurality of disc wavelengths.

17. The method of claim 16 further comprising interpolating the air bearing transfer function with gradations of the wavelengths to provide the air bearing transfer function with enhanced spectral lines.

18. An apparatus for determining head-media spacing (HMS) due to waviness of a disc media surface, comprising:
means for generating an interpolated air bearing transfer function for a spectral density and a power spectral density function for a sample topography spectrum; and
means for providing an HMS modulation spectrum for the sample topography spectrum using the power spectral density function and the air bearing transfer function.

19. The apparatus of claim 18 further comprising means for summing the HMS modulation spectrum to provide a value for the HMS of the disc media surface sampled.

20. The apparatus of claim 19 wherein the means for generating comprises means for simulating disc topography.
